(19) United States
(12) Patent Application Publication
(10) Pub. No.: US 2015/0149195 A1
(43) Pub. Date: May 28, 2015

(54) WEB-BASED INTERACTIVE RADIOGRAPHIC STUDY SESSION AND INTERFACE

(71) Applicant: Greg Rose, Littleton, CO (US)

(72) Inventor: Greg Rose, Littleton, CO (US)

(21) Appl. No.: 14/092,997

(22) Filed: Nov. 28, 2013

(51) Int. Cl. G06F 19/00; G06F 3/0481; G06F 3/0484; H04N 7/15; H04L 29/06

(52) U.S. Cl. CPC G06F 19/3418; G06F 19/321; H04N 7/15; H04L 65/1066; G06F 3/04842; G06F 3/04817
USPC 705/2

(57) ABSTRACT

An interactive radiographic study session and method of invoking the session are disclosed. The radiographic study includes one or more radiographic images viewed on a computer monitor or other display-type device. The interactive radiographic study session enables a radiologist to share a view of the radiographic study with one or more clinicians. The clinician requests the session by selecting the radiologist or by selecting a patient. The interface may employ a web-based mechanism, or another means to provide a computer-system-based connection between the clinician and the radiologist. An interactive interface includes real-time video of each party to the session, and allows the radiologist to give control of his mouse to the clinician, enhancing communication between them during viewing of the radiographic images. The interface also includes tools to enable scrolling through the report, enlargement and marking of radiographic images, and other features.

### TECHNICAL FIELD

This application relates to services and techniques to enhance communication between a radiologist and a clinician.

### BACKGROUND

Radiology is a branch of medicine in which various imaging techniques may be employed to diagnose and treat a wide variety of diseases. Named for the radioactive substances used to produce the images, radiologists, also known as clinical radiologists, may employ many techniques for imaging the patient, including magnetic resonance imaging (MRI), computed tomography (CT, or “cat scan”), ultrasonography (US), nuclear medicine (NM), x-ray/plain film, angiography, and fluoroscopy, to name a few. In addition to their medical education, radiologists receive training in reading and interpreting radiographic images.

To facilitate diagnosis and treatment, a patient's physician, such as a general practitioner, may order one or more radiology tests on the patient. A radiology technologist positions the patient before the imaging apparatus and initiates the imaging function, which produces the radiographic image. Rarely, the patient's physician is capable of interpreting the radiographic image. In many environments, such as hospitals and group practices, the task of interpreting the image is left to the radiologist.

With such division of labor prevalent in medicine, the patient is rarely in communication with the radiologist directly. Thus, before interpreting the radiologist images, the radiologist may prefer or require additional patient information from the physician, such as historical information, known symptoms, and other communication obtained by the patient's physician. Once the radiographic image and the additional patient information are received, the radiologist produces one or more reports. The patient physician is able to diagnose and treat the patient, in large part, based upon the report(s).

Radiographic images are ordered in the diagnosis of a number of different patient maladies. While the patient with a common cold may avoid being imaged, patients with broken bones, pregnant women, and cancer patients routinely obtain radiographic images prior to diagnosis or during treatment. The successful operation of a medical facility, such as a hospital or group practice, therefore, depends on the availability of one or more radiologists at all times and the efficient interpretation of radiographic images by the radiologist.

The availability of radiologists and radiology services during weekends and after-hours may be particularly problematic, as many facilities do not have a radiologist present during these hours. Further, many physicians may not have radiology equipment (even x-ray machines) on-site, and may thus send the patient to a radiology laboratory to obtain the images, which are then returned to the diagnosing physician. The delays associated with these conditions may impair the ability of the diagnosing physician to successfully and timely treat the patient.

In the past, radiology clinics principally employed printed film to capture the radiographic image, which the radiologist then physically hung on “view boxes” to illuminate the image. Today, many of the radiographic images generated using the techniques enumerated above may be stored digitally and viewed on computer displays.

Once the radiographic image has been generated, the radiologist conducts a study of the radiographic image, usually, by dictation. The radiologist's voice is changed into text, which is then automatically displayed on a video monitor. The study is now ready for the clinician to review.

The clinician reads through the report(s) and selects the radiographic images (there may be several), such as by clicking them with a mouse on the video monitor. If the clinician wants to review the study with a radiologist, the clinician usually calls or sends electronic mail to the radiologist, thus resulting in a delay to completion of the clinician's job. Alternatively, the radiologist may desire a personal interaction with the clinician on the study, such as where new ground is covered. In either case, completion of the study is impaired, due to the different schedules between the radiologist and the clinician, the availability of either party during the other's schedule, and so on.

The coordination issues are compounded when there are multiple clinicians who need to interpret the study. Further, the doctor who originated the study may desire to communicate further with the radiologist. The radiologist may have communicated with one party about the study, only to have to repeat the communication with another party. There may be complicated or learning cases where it would be useful to have the expert radiologist who read the case give a brief video demonstration rather than having to dig through the report to find the images. If the dictating radiologist is not available, a different radiologist (who is likely to be unfamiliar with the case) must start anew, interpret the case, compare his findings to the original reader, and then explain the case to the interested clinician.

Thus, there is a continuing need for an interactive mechanism by which a radiographic study, as well as real-time input from the radiologist, is available to clinicians.

### BRIEF DESCRIPTION OF THE DRAWINGS

The foregoing aspects and many of the attendant advantages of this document will become more readily appreciated as the same becomes better understood by reference to the following detailed description, when taken in conjunction with the accompanying drawings, wherein like reference numerals refer to like parts throughout the various views, unless otherwise specified.

FIG. 1 is a simplified diagram of an interactive radiographic study session 200, according to some embodiments;

FIGS. 2A and 2B are two views of an interactive radiographic study interface, one from the clinician's view and the other from the radiologist's view, according to some embodiments;

FIG. 3 is a simplified diagram showing the tools used by the clinician and the radiologist in invoking the interactive radiographic study interface, according to some embodiments;

FIG. 4 is a simplified diagram of software used by the interactive radiographic study interface, according to some embodiments;

FIGS. 5A and 5B are schematic diagrams of a radiologist tracking software graphical user interface, used to invoke the interactive radiographic study interface, according to some embodiments;

FIGS. 6A and 6B are schematic diagrams of a radiologist's response to an invocation of the interactive radiographic study interface by a clinician using the radiologist tracking software of FIGS. 4A and 4B, according to some embodiments;

FIGS. 7A-7C are schematic diagrams of a patient tracking software graphical user interface, used to invoke the interactive radiographic study interface, according to some embodiments;

FIGS. 8A and 8B are schematic diagrams of a radiologist's response to an invocation of the interactive radiographic study interface by a clinician using the patient tracking software of FIGS. 5A and 5B, according to some embodiments;

FIG. 9 is a screen shot of a radiologist tracking software graphical user interface, used by a clinician to invoke the interactive radiographic study interface, according to some embodiments;

FIGS. 10A and 10B are screen shots viewed by the radiologist and clinician, respectively, once the interactive radiographic study session has been invoked, according to some embodiments;

FIG. 11 is a flow diagram featuring the steps performed between the clinician and the radiologist in invoking the interactive radiographic study interface, according to some embodiments;

FIG. 12 is a flow diagram featuring the steps performed between the clinician and the radiologist in controlling the cursor movements on the screen using the interactive radiographic study interface, according to some embodiments;

FIG. 13 is a simplified diagram showing the interactive radiographic study interface, including control logic for invoking and ending a session, as well as mouse control logic, according to some embodiments; and

FIG. 14 is a simplified diagram showing how the interactive radiographic study software produces the interface as well as results to be stored and cross-linked to other data stored in a database, according to some embodiments.

### DETAILED DESCRIPTION

In accordance with the embodiments described herein, an interactive radiographic study session and method of invoking the session are disclosed. The radiographic study includes one or more radiographic images viewed on a computer monitor or other display-type device. The interactive radiographic study session enables a radiologist to share a view of the radiographic study with one or more clinicians. The clinician requests the session using proprietary software available to the clinician, using the web, or using other means. The radiologist may be the radiologist who generated the radiology report, a radiologist with whom the clinician has worked, an available radiologist, or a radiologist selected according to some other criteria. The interface may employ a web-based mechanism, or another means to provide a computer-system-based connection between the clinician and the radiologist. An interactive interface includes real-time video of each party to the session, and allows the radiologist to give control of his mouse to the clinician, enhancing communication between them during viewing of the radiographic images. The interface also includes tools to enable scrolling through the report, enlargement and marking of radiographic images, and other features.

In the following detailed description, reference is made to the accompanying drawings, which show by way of illustration specific embodiments in which the subject matter described herein may be practiced. However, it is to be understood that other embodiments will become apparent to those of ordinary skill in the art upon reading this disclosure. The following detailed description is, therefore, not to be construed in a limiting sense, as the scope of the subject matter is defined by the claims.

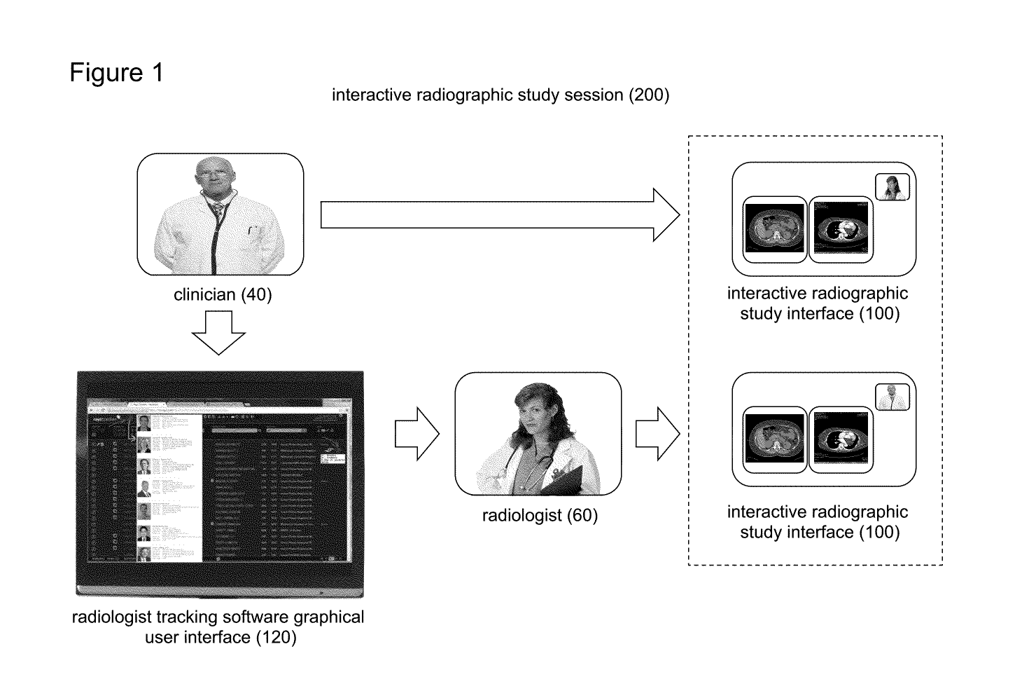

FIG. 1 is a simplified diagram depicting steps involved in invoking an interactive radiographic study session 200, according to some embodiments. The interactive radiographic study session 200 allows the clinician 40 to easily contact a radiologist through his computer. A clinician 40 accessing either a radiologist tracking software graphical user interface (GUI) 120 or some other software that includes a list of radiologists available to conduct a session with the clinician 40. The clinician 40 selects one of the radiologists from the selection. (Alternatively, the clinician 40 accesses a patient tracking software GUI 90 and selects a patient, with the patient being associated with a radiologist.)

Once selected by the clinician 40, the radiologist 60 is notified and the interactive radiographic study session 200 begins. An interactive radiographic study interface 100 becomes available to both the clinician 40 and the radiologist 60, with the clinician's view of the interface showing a video of the radiologist 60 and the radiologist's view of the interface showing a video of the clinician 40.

In the following description of the interactive radiographic study session 200 and the method of invocation, feminine pronouns are used to describe the radiologist 60 while masculine pronouns are used to describe the clinician 40. This is purely to avoid confusion between the two entities in describing the many characteristics and operations performed by the parties in employing the interactive radiographic study session 200.

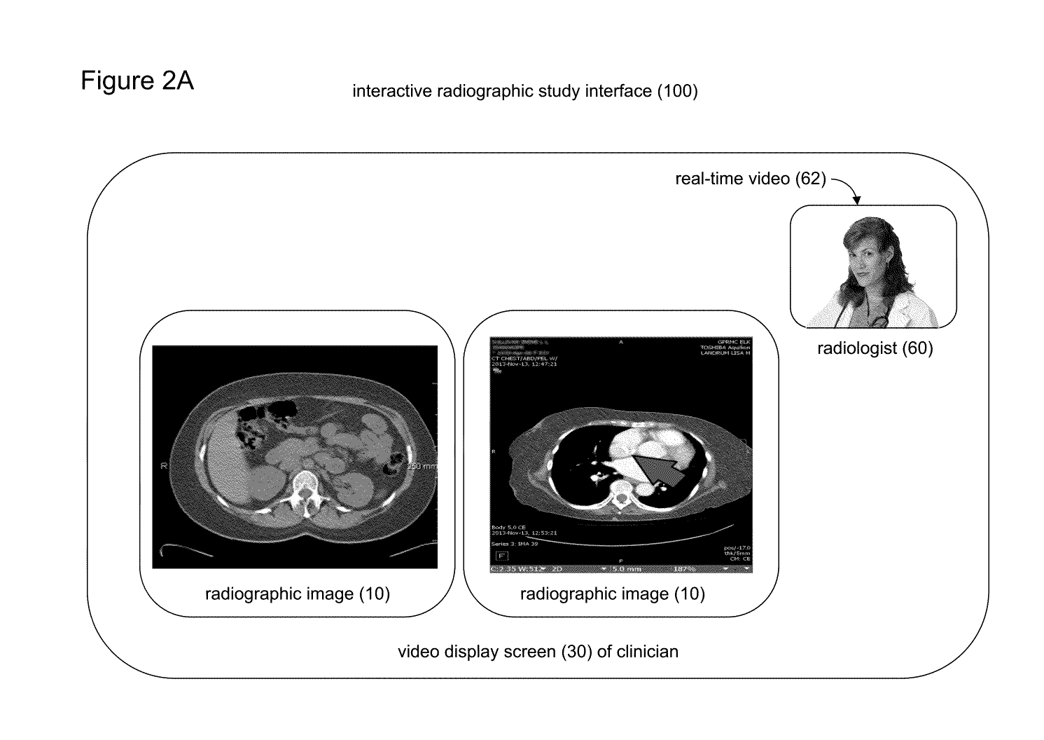

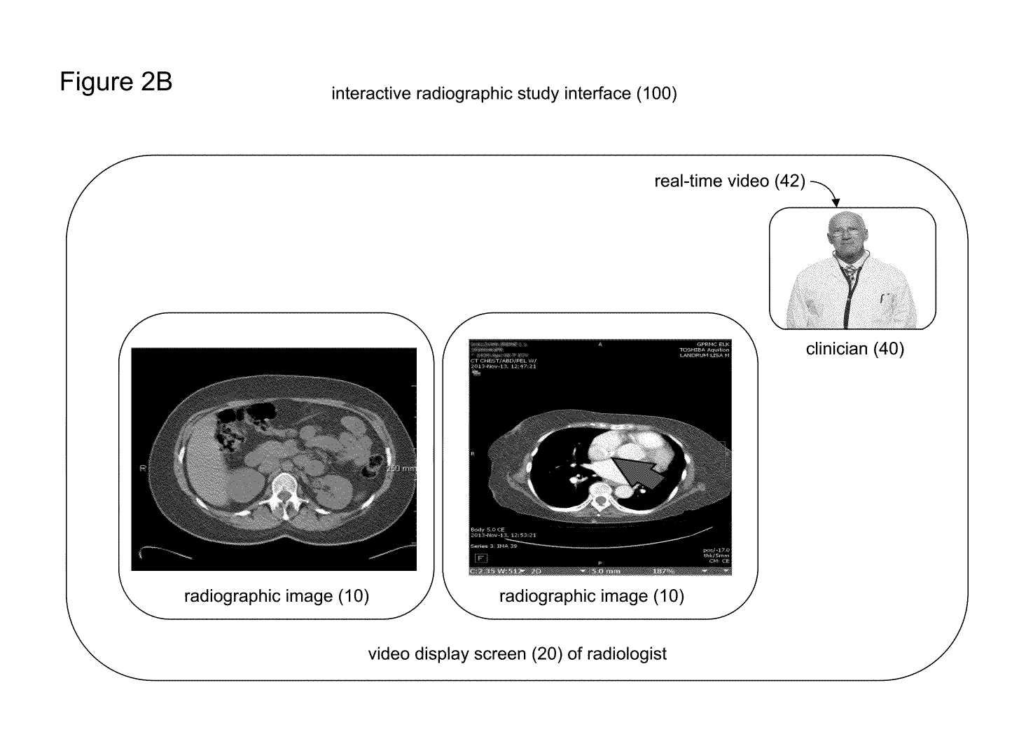

FIGS. 2A and 2B are simplified diagram of the interactive radiographic study interface 100, according to some embodiments. The radiographic study interface 100 is part of an interactive radiographic study session 200 that enables clinicians and radiologists to interactively confer with one another about a patient's radiographic images (RIs). FIG. 2A shows the interactive radiographic study interface 100 from the clinician's perspective (i.e., what is displayed on the clinician's computer screen) and FIG. 2B shows the interface 100 from the radiologist's perspective.

In FIG. 2A, a video display screen 30 of the clinician 40 is shown. A real-time video 62 of the radiologist 60 is visible in one are of the screen 30 (in this example, the video is at the upper right portion). One or more radiographic images 10 are visible to the clinician 40. In FIG. 2B, a video display screen 20 of the radiologist 60 is shown. This time, a real-time video 42 of the clinician 40 is visible in an area of the screen 20. The same radiographic images 10 visible to the radiologist 60 are also visible to the clinician 40.

The interactive radiographic study interface 100 may be web-based or proprietary. In either case, the clinician 40 and the radiologist 60 each have access to a processor-based system or other computing device capable of executing and storing the software necessary to operate the interface 100. Further, the radiologist 60 has installed on his computing device software 78 that enables presentation of the radiographic images 10. There are several software programs available to display radiographic images. Visage Imaging is one example of such software programs. (Visage Imaging is a product of ProMedicus Limited of Richmond, Victoria, Australia.)

The clinician 40 appears on the interactive radiographic study interface 100 as a real-time video image 42, seen by the radiologist 60. Likewise, the radiologist 60 appears on the interface as a separate real-time video image 62, seen by the clinician 40. In some embodiments, the clinician 40 and the radiologist 60 are accessing the interactive radiographic study interface 100 from separate computers.

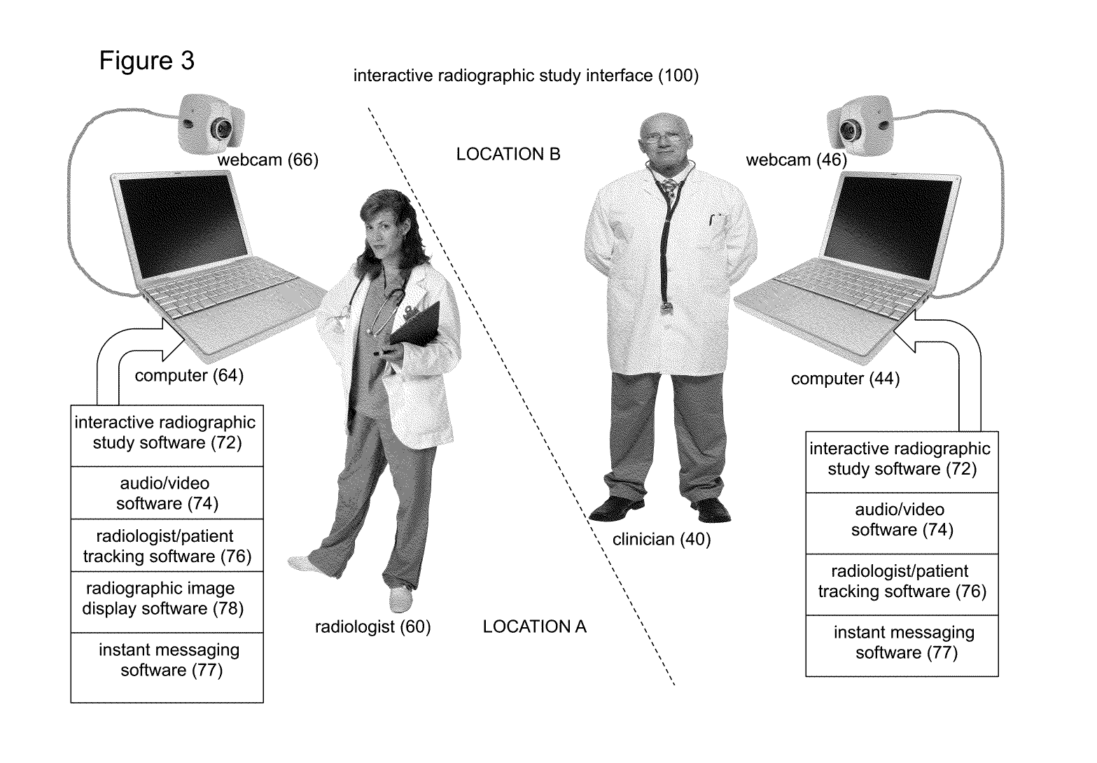

FIG. 3 is a simplified diagram showing the radiologist 60 at location A operating a computer 64 with an attached webcam 66 while the clinician 40 at location B is operating a second computer 44 with its own attached webcam 46. Location A and location B may be in adjacent offices, in separate buildings, across town, or even on different continents. Depicted in FIG. 3 as laptop computers 44, 64, the computers may alternatively be desktop computers, servers, tablets, pads, or smartphones devices, as long as the device has a processor and the capability to load software thereon as well as having either an embedded camera or the capability to connect to a webcam.

The webcams 46, 66 coupled to the respective computers 44, 64 enable the video capture of the clinician 40 and the radiologist 60 that is presented to the interactive radiographic study interface 100. A webcam is simply a digital camera attached to a computer, such as by a universal serial bus (USB) connection. The digital camera operates with image processing software 74 running on the computer. The software retrieves a frame from the camera at a specified frame rate, converts the frame into a suitable viewing format, and sends the formatted frame to the interface 100. For streaming video, the frame rate is preferably 15 frames per second (fps) or more, with 30 fps being ideal for undisturbed viewing. For web-based and other implementations, the frame may be converted into a JPEG image and uploaded to a web server.

Thus, in some embodiments, the clinician 40 is sitting at the computer 44 (location B) with the attached digital camera 46, with the image processing software 74 running in the computer to produce a video of the clinician. Similarly, the radiologist 60 is sitting at the computer 64 (location A) with attached digital camera 66, with the computer also running image processing software 74 to produce a video of the radiologist. Each video is uploaded to the interactive radiographic study interface 100 using interactive radiographic study software 72 that creates the interface. Where the interface 100 is web-based, the video may be uploaded using file transfer protocol (FTP). Thus, the web page hosting the interface 100 includes a video 42 of the clinician 40 or a video 62 of the radiologist 60, depending on the viewer, and one or more radiographic images 10.

The interactive radiographic study interface 100 enables the clinician 40 to contact the radiologist 60 using the interface. Traditionally, after obtaining one or more radiographic images of a patient, whether as x-rays, CAT scans, MRIs, and so on, the clinician waits for the radiologist to generate a study detailing the radiologist's findings about the images. The clinician reviews the study and perhaps conducts a follow-up meeting with the radiologist. The time between the imaging of the patient and a complete diagnosis by the clinician of the patient depend upon how long it takes the radiologist to obtain the images, when the radiographic study of the images is conducted, when the radiographic study is available to the clinician, and other factors.

Using the interactive radiographic study interface 100, the clinician obtains facile and quick access to the radiologist, in some embodiments. In some embodiments, the clinician 40 invokes the interactive radiographic study interface 100 using radiologist/patient tracking software 76, which is also loaded on the computers of both the clinician 40 and the radiologist 60. The tracking software 76 includes a list of radiologists working in the practice, a list of patient clients of the practice, or both radiologists and patients. Hospitals and other networks of physicians often have software of this type to facilitate their practice. One such system is the subject of U.S. Pat. No. 7,813,942, entitled, AFTER-HOURS RADIOLOGY SYSTEM, issued on Oct. 12, 2010, and is incorporated by reference herein as if originally presented in its entirety. The after-hours radiology system is a web-based system that collates patient information including radiographic image(s), an interpretation of the images by the radiologist, known as a radiographic study, patient history, and other information and stores the information to a database accessible to the practice.

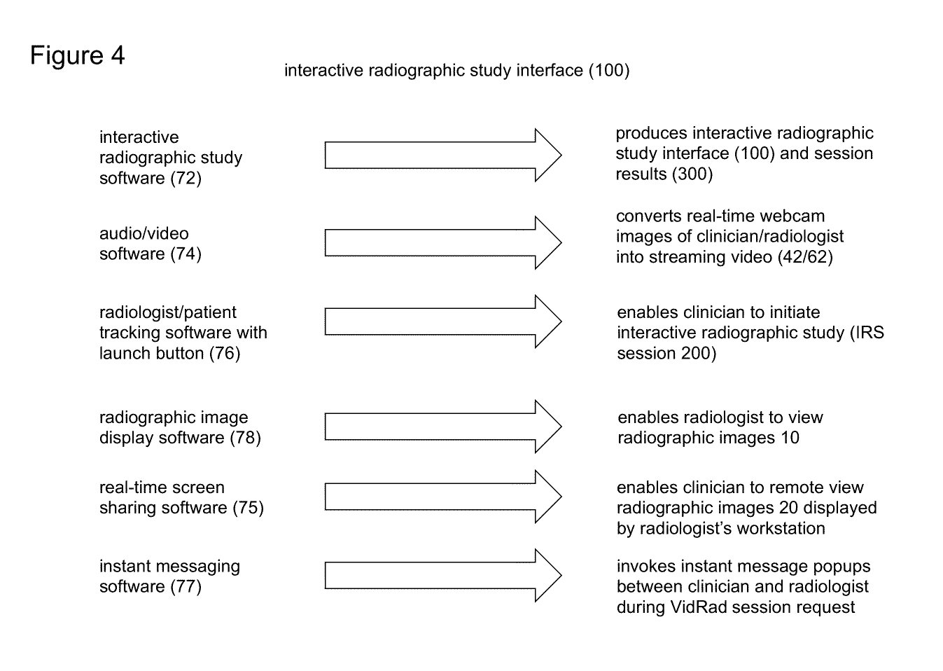

FIG. 4 is a simplified diagram showing the software programs involved in the interactive radiographic study interface 100, according to some embodiments. Loaded on both the computer 44 of the clinician 40 and the computer 64 of the radiologist 60 are the interactive radiographic study software 72, the audio/video software 74, the radiologist/patient tracking software 76, real-time screen sharing software 75, and instant messaging software 77. Loaded only on the computer 64 of the radiologist 60 (but nevertheless viewable by the clinician 40 during the interactive radiographic study interface sessions 200) is the radiographic image display software 78. The interactive radiographic study interface 100 thus exploits already available off-the-shelf software (the image processing 74 and RI display software 78), in-house proprietary software such as the radiologist/patient tracking software 76, and utilizes newly developed software (the interactive radiographic study software 72).

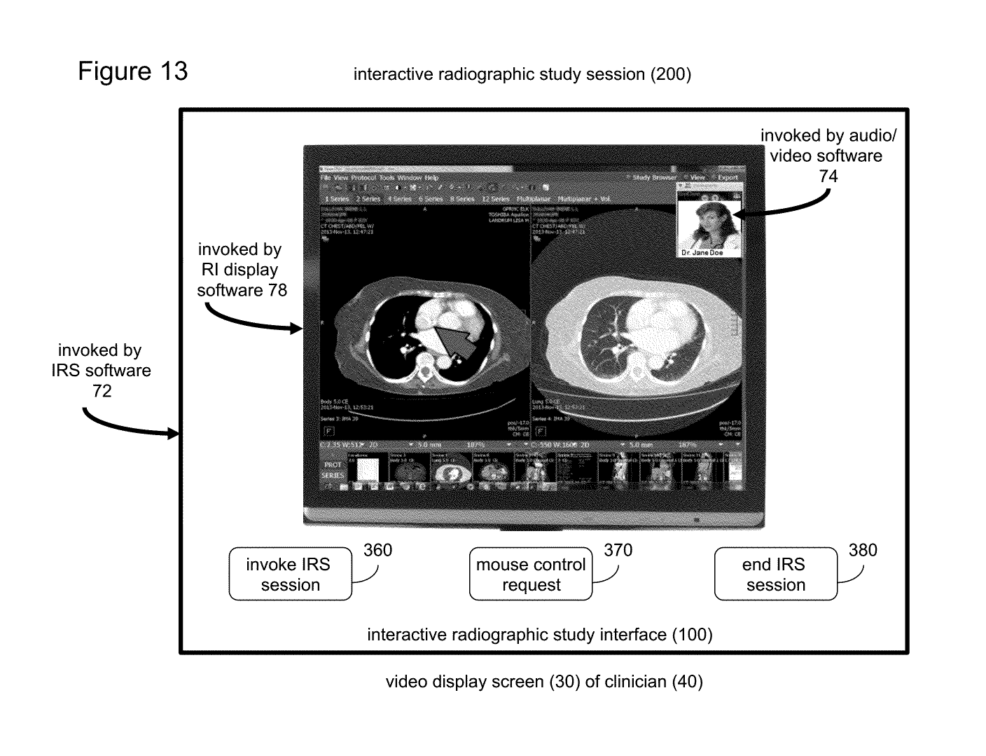

The interactive radiographic study (IRS) software 72 is executed on the laptop or other computer workstation 44 of the clinician 40 so that the interactive radiographic study interface 100 appears on the display. Additionally, the IRS software 72 generates session results 300, as described in more detail below. In some embodiments, the IRS software 72 either incorporates other software components or is able to invoke execution of those components, as illustrated in FIG. 13.

The IRS software 72 may invoke the audio/video software 74, which enables real-time audio and video communication between the clinician 40 and the radiologist 60, for example. The IRS software 72 may also invoke the real-time screen sharing software 75. In some embodiments, the real-time screen sharing software 75 employs WebEx, an on-demand collaboration software that enables web conferencing, desktop sharing, online meetings, and videoconferencing. (WebEx is a product of WebEx Communications of Santa Clara, Calif.)

The interactive radiographic study software 72 is also able to invoke the instant messaging software 77, in some embodiments. Instant messaging is accessible to anyone having the instant messaging software installed on the workstation. Once a client on the workstation is opened, the client tries to connect to a remote server, the client logs in, sends the server the connection information (e.g., IP address). Once a person in the client's address book is available and selected by the workstation owner, a an instant message window opens that enables text to be entered therein, and, once sent, direct communication takes place between the workstation owner and the person. In other embodiments, the IRS software 72 includes its own proprietary instant messaging-type software.

In some embodiments, the other two software pieces illustrated in FIG. 4, the radiographic image display software 78 and the radiologist/patient tracking software 76, are not part of the IRS software 72. In some embodiments, the radiologist/patient tracking software 76 includes a launch button that invokes the IRS software 72, as is illustrated below.

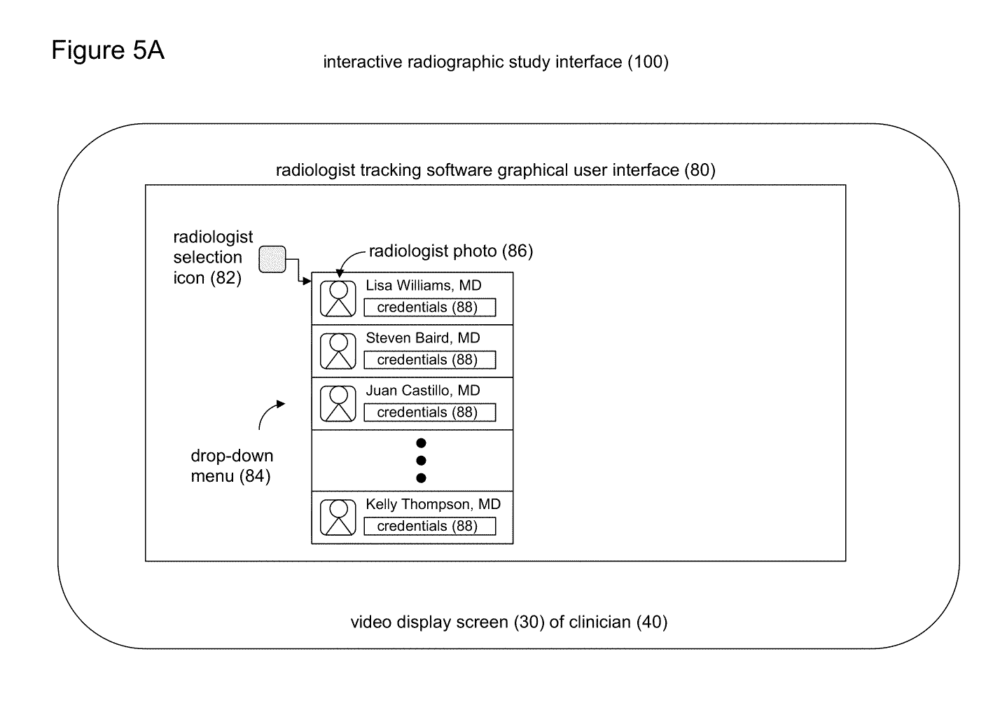

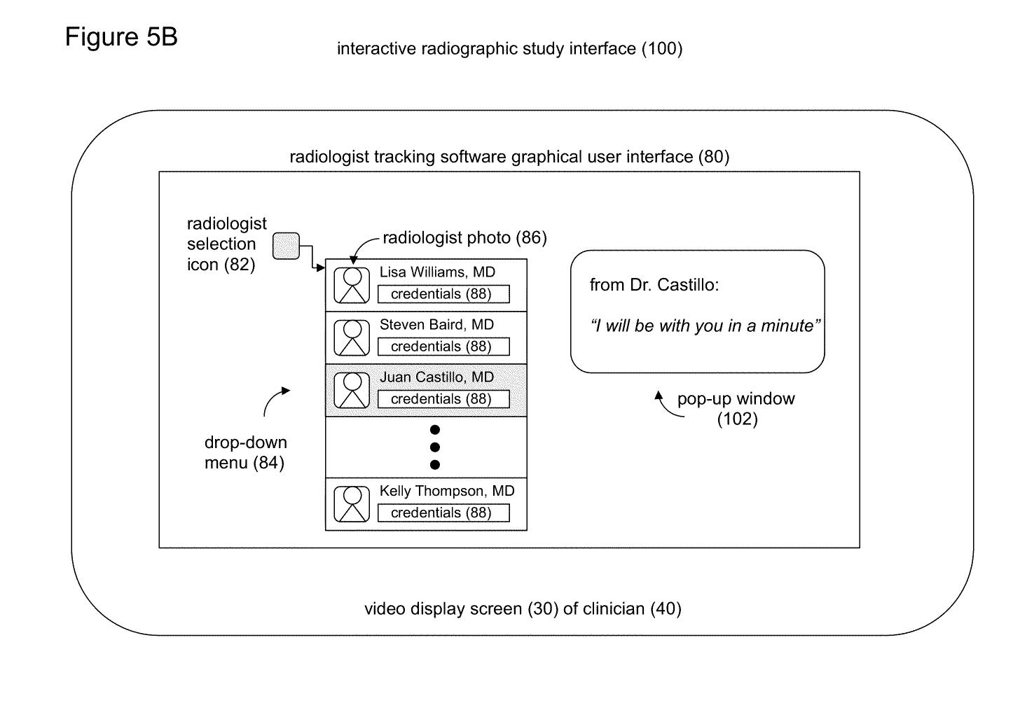

In some embodiments, the interactive radiographic study session 200 envisions using software already available to the medical practice as the launching off point for accessing the interface. FIGS. 5A and 5B provide examples that should illuminate the motivation for launching the interface 100 from such already available software 76, according to some embodiments.

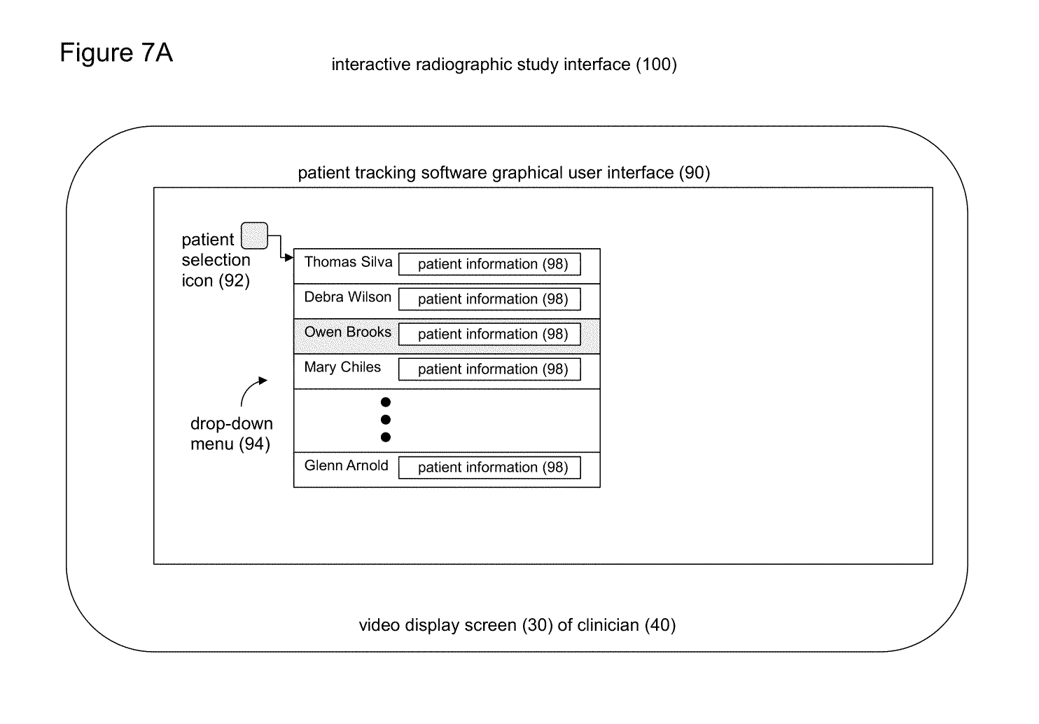

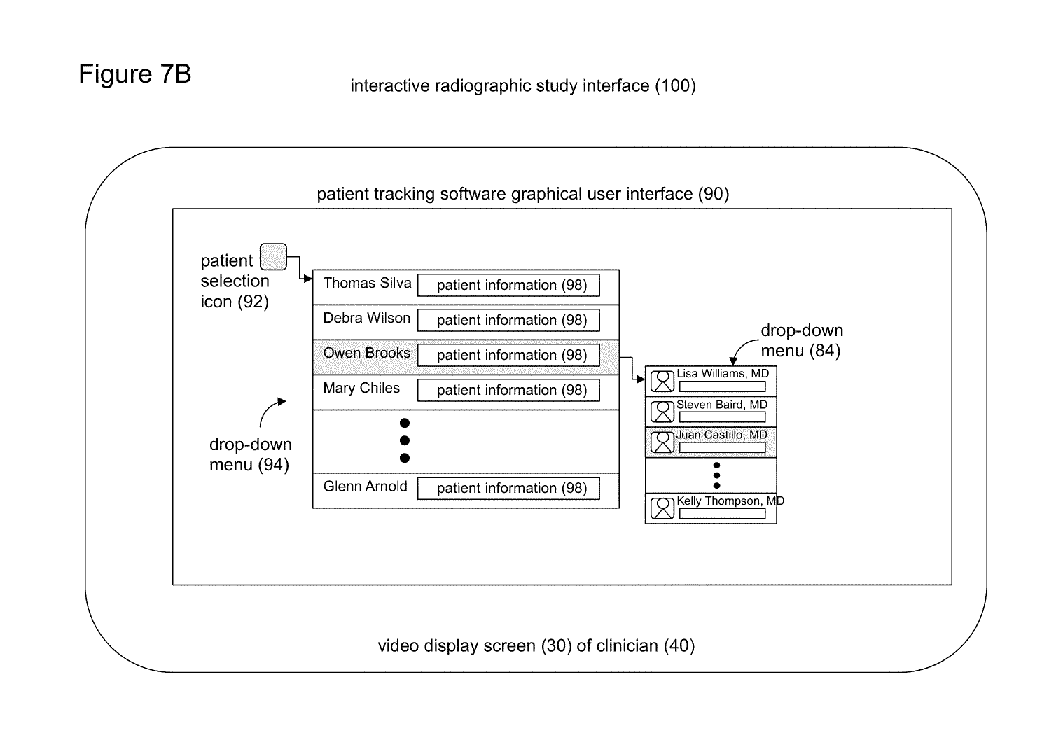

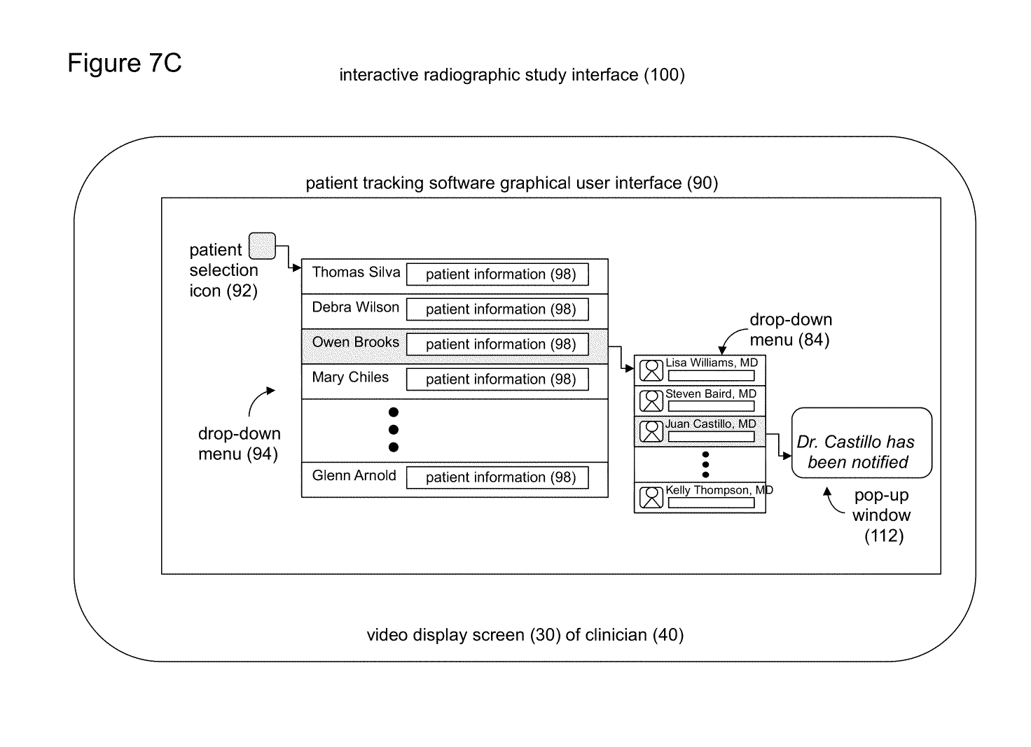

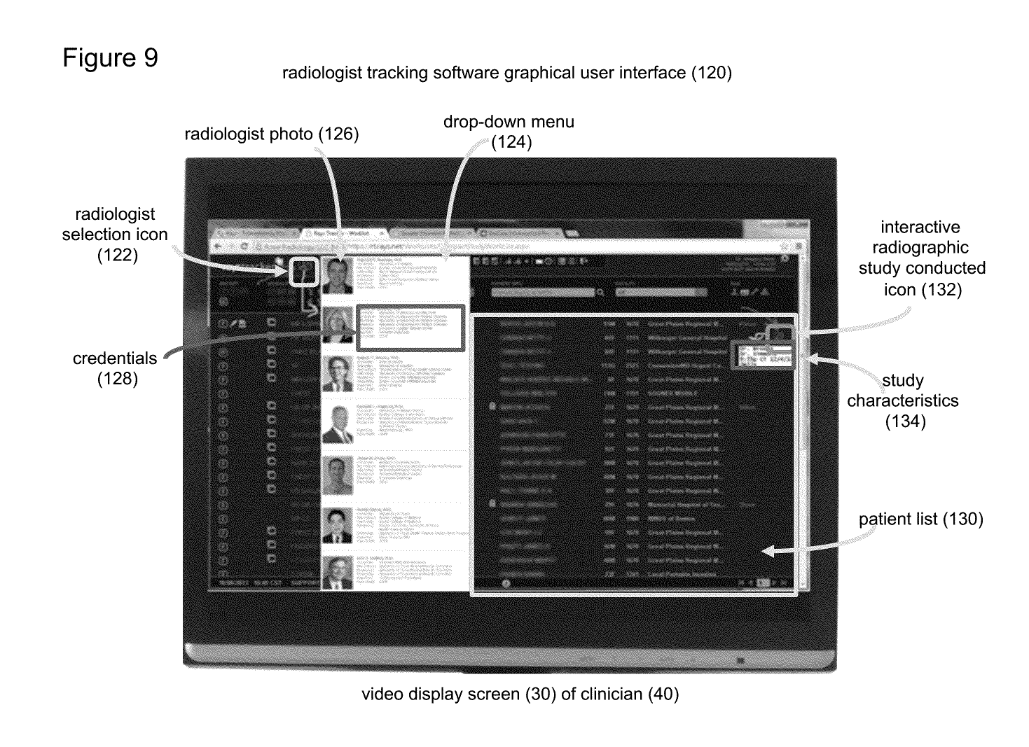

Both figures present simplified views of what the radiologist/patient tracking software 76 might look like, in some embodiments. In FIG. 5A, a graphical user interface (GUI) 80 of the tracking software 76 is geared toward radiologists; in FIGS. 7A-7C, a second GUI 90 of the tracking software 76 is geared toward patients. (It is possible to have both patients and radiologists viewable from the GUI, as illustrated in FIG. 9.)

Since the clinician 40 invokes the interactive radiographic study session 200 through the tracking software 76, FIGS. 5A and 5B show the video display screen 30 of the clinician. Nevertheless, the software 76 is also used by the radiologist 60 (FIG. 4). FIG. 5A features the radiologist tracking software GUI 80, visible on the video display 30 of the clinician 40. A radiologist selection icon 82 is selectable by the clinician 40, which invokes a drop-down menu 84 of radiologists in the practice. In some embodiments, a list of radiologist photographs, radiologist names, the radiologist's expertise, and years in the practice pops up in the drop-down menu 84. In this example, a photo 86 of each radiologist is part of the drop-down menu, along with the radiologist's name and credentials 88. Credentials 88 may include, but are not limited to, the radiologist's area of expertise, years in practice, and years with the particular medical group of which the clinician is a practitioner. Other information such as operating hours may be included in the credentials 88.

In some embodiments, once the clinician 40 selects one of the radiologists 60 in the drop-down menu 84, a new interactive radiographic study session 200 is invoked. This initiates a handshaking between clinician 40 and radiologist 60 that eventually results in the interactive session 200. FIG. 5B again depicts the video display screen 30 of the clinician 40, this time showing that the clinician has selected “Juan Castillo, MD” from the drop-down menu 84, which automatically causes a pop-up window 102 to appear on the screen 30. The pop-up window 102 is an acknowledgement from the selected radiologist (Dr. Castillo) to the clinician 40 that he saw the request.

The radiologist selection icon 82 may also be thought as the means with which to invoke the radiographic study session 200, since its selection starts the events that result in the session. In other embodiments, a dedicated button or icon is visible in the radiologist tracking software 76 to invoke the session 200.

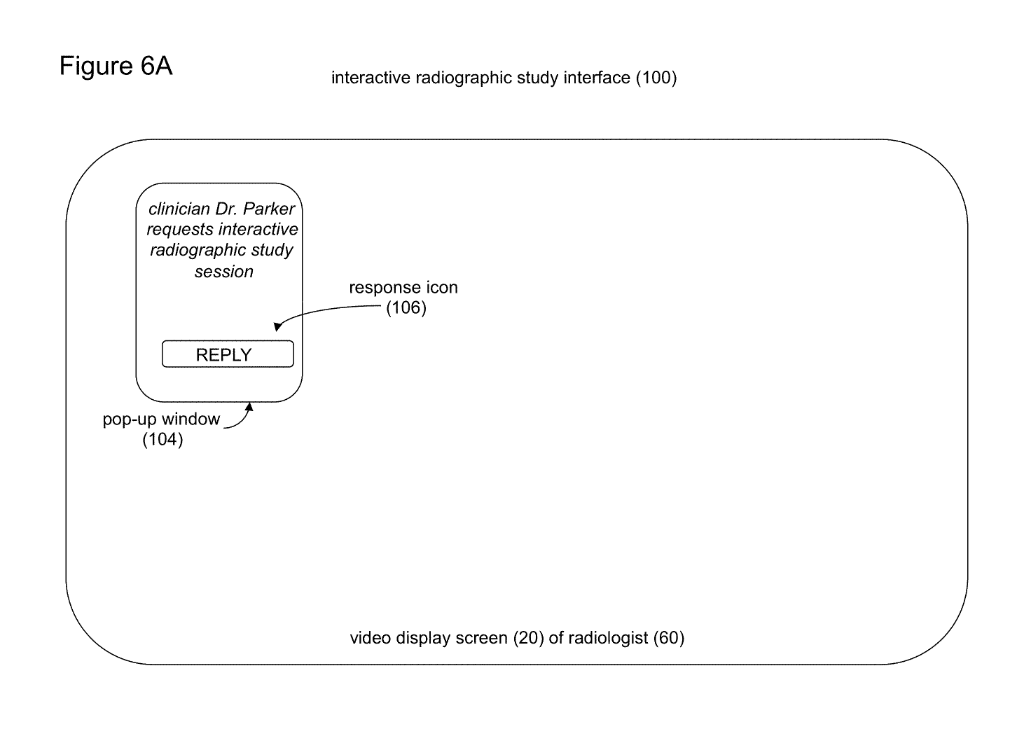

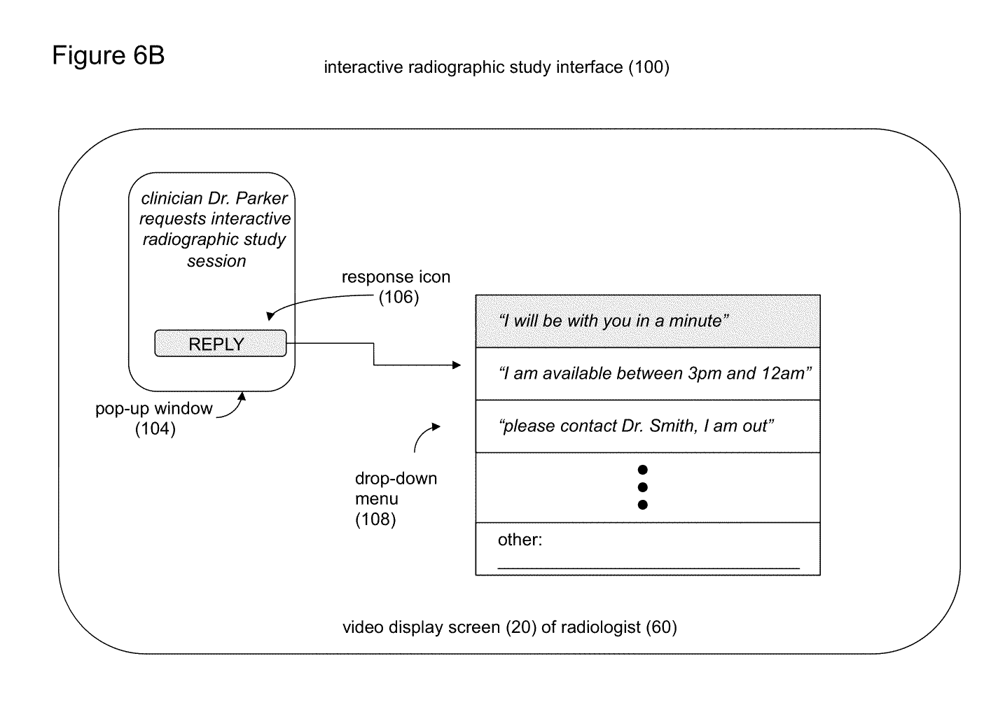

FIGS. 6A and 6B feature the video display screen 20 of the radiologist 60 during the clinician request, according to some embodiments. In FIG. 6A, the radiologist 60 may have a program loaded and running on the system or may have no program running at all, with what is commonly known as “the desktop” being the only image presented on the screen. In either case, once the clinician 40 requests a particular radiologist 60, that radiologist sees a pop-up window 104, such as that seen in FIG. 6B, indicating a pending request.

In some embodiments, the pop-up window 104 is presented to the screen 20 of the radiologist 60 using a mechanism similar to instant messaging. Where an instant messaging-type protocol is used, the radiologist 60 must have the instant messaging software loaded onto her computer 64 and the clinician 40 must also have the instant messaging software loaded onto his computer 44. In other embodiments, the pop-up window 104 is simply a portion of the IRS software 72.

In any case, the pop-up window 104 presented to the video display screen 20 of radiologist Dr. Juan Castillo indicates what is happening. In this example, the popup window says, “Clinician Parker requests interactive radiographic study session.” The pop-up window 104 further includes a response icon 106. In this example, the response icon 106 is denoted with the word, “reply” thereon.

FIG. 6B, still showing the video display screen 20 of the radiologist 60, illustrates that, once Dr. Castillo selects the response icon 106, a drop-down menu 108 is displayed. In some embodiments, the drop-down menu 108 includes prepared or “canned” responses that the radiologist 60 might select in replying to the clinician request, with one option, “other,” enabling the radiologist to type in a tailored response not found in the already prepared responses. As shown in FIG. 6B, Dr. Castillo has selected the first prepared response, “I will be with you in a minute.”

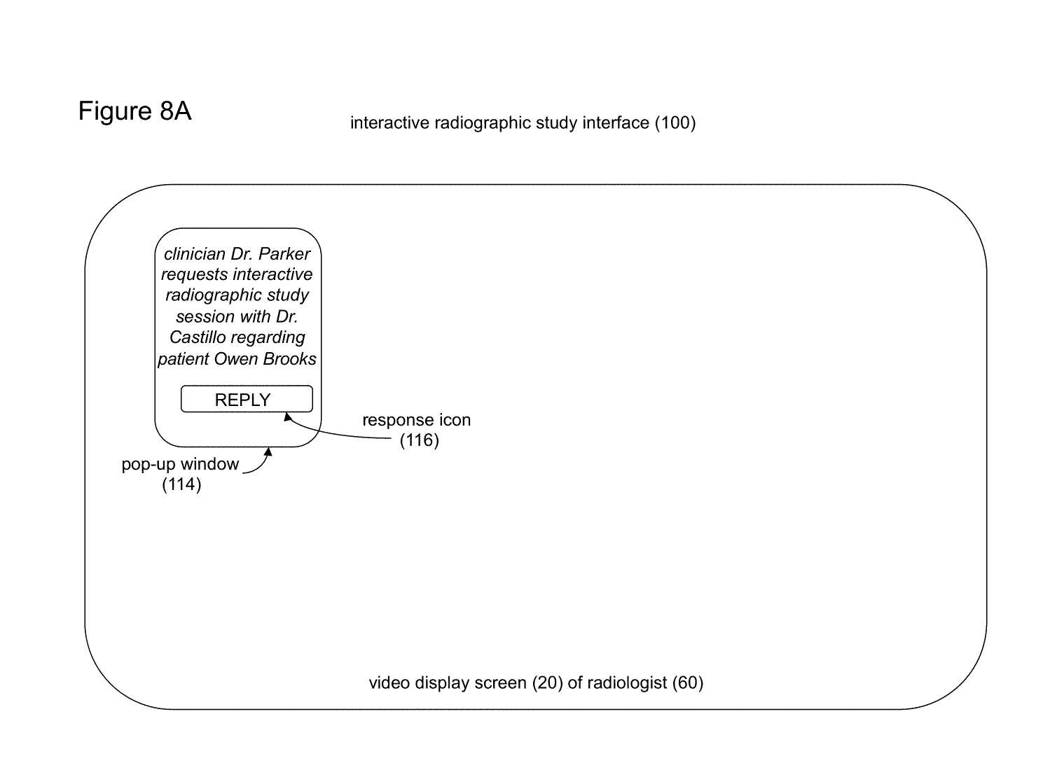

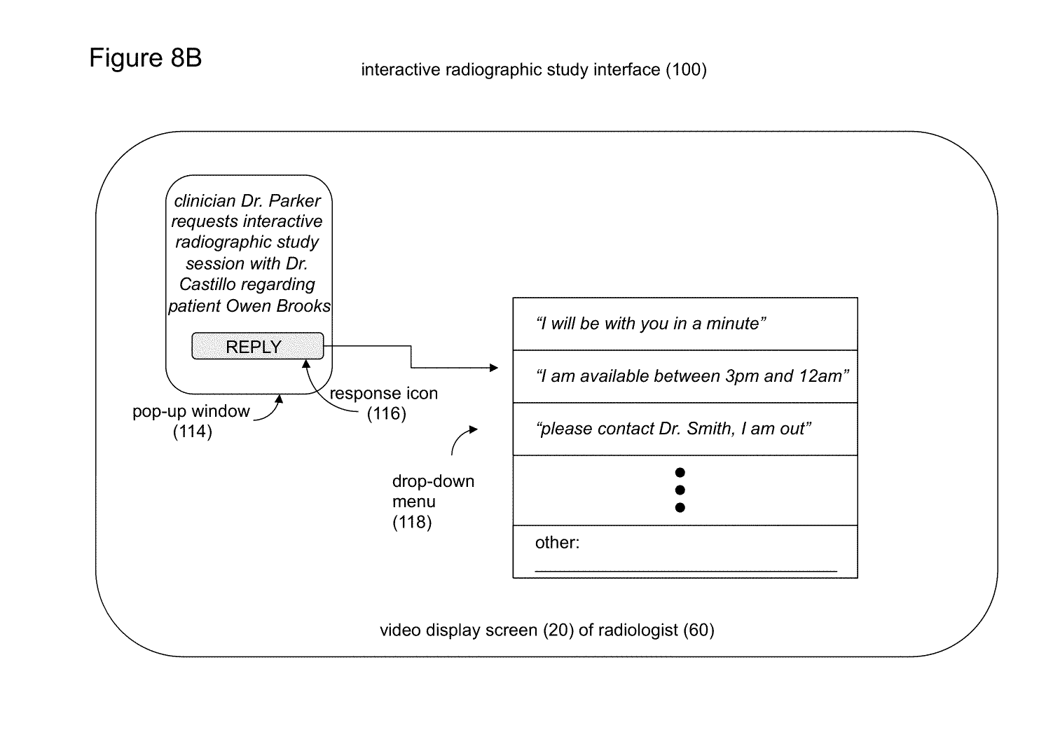

Before describing the additional handshaking operations conducted between the radiologist 60 and the clinician 40, a second possible way to invoke the session 200 is illustrated in FIGS. 7A-7C and 8A-8B, according to some embodiments. In FIG. 7A, the video display screen 30 of the clinician 40 is visible. This time, instead of radiologist tracking software, the clinician 40 has patient tracking software loaded onto his computer 44 and a patient tracking software GUI 90 is visible on the screen 30. A patient selection icon 92 enables the clinician 40 to select from a drop-down menu 94 of available patients. On each line, a patient name is followed by patient information 98, which may include any and all information gathered by the facility about that patient. A history of visits to the facility, a listing of radiographic images obtained for the patient, and a report by the radiologist may be part of the patient information 98, as examples.

In FIG. 7B, the clinician 40 has selected patient Owen Brooks. In this example, once the patient selection is made, a drop-down menu 84 appears on the screen, indicating a list of radiologists available. The filter for which radiologists 60 appear in the drop-down menu 84 may vary. Once the clinician 40 selects a radiologist, as illustrated in FIG. 7C, a pop-up window 112 appears on the screen, acknowledging the selection by the clinician 40. The patient is automatically associated with radiologist Dr. Juan Castillo, and the pop-up window 112 indicates that the radiologist has been notified of the request.

In the embodiments of FIGS. 7A-7C, the clinician 40 selects both the patient and the radiologist 60. In other embodiments, an association between the patients and a radiologist may be made by the interactive radiographic study software 72 automatically for the clinician 40. Thus, the election of the name, “Owen Brooks” automatically caused “Dr. Juan Castillo” to be associated. In other embodiments, selection of both the patient and the radiologist may be made by the clinician 40.

The patient selection icon 92 may also be thought as the means with which to invoke the radiographic study session 200, since its selection starts the events that result in the session. In other embodiments, a dedicated button or icon is visible in the patient tracking software 76 to invoke the session 200.

FIGS. 8A and 8B illustrate the video display screen 20 of the radiologist 60, in this case, Dr. Juan Castillo. Again, it does not matter what programs are currently running on Dr. Castillo's computer, the notification pop-up window will happen no matter what. In FIG. 8A, a pop-up window 114 indicates that a clinician 40 is requesting the radiologist for a session 200. In contrast to the example in FIG. 8B, since the patient Owen Brooks has already been selected by the clinician 40, that information is presented to the radiologist 60 in the pop-up window 114, thus enabling the radiologist to retrieve the information about the patient without further inquiry of the clinician. The pop-up window 114 includes a response icon 116 (denoted, “reply”).

In FIG. 8B, once the radiologist 60 selects the response icon 116, a drop-down menu 118 of predetermined responses becomes available for selection, as well as an “other” response that enables the radiologist to type in a unique or tailored response. Thus, the initial handshaking operations between clinician 40 and radiologist 60 have begun.

FIG. 9 is a screenshot of an actual radiologist tracking software GUI 120, used by a clinician 40 to initiate an interactive radiographic study session 200, according to some embodiments. The radiologist tracking software GUI 120 appears on the clinician's video display screen 30 when the radiologist tracking software 76 is executed by a processor on the clinician's computing device, whether laptop, smartphone, notebook, etc. A radiologist selection icon 122 (outlined in yellow), once chosen by the clinician 40, causes a drop-down menu 124 to appear, which includes a list of radiologists according to some criteria. (Filters may be applied such that only radiologists currently on duty, radiologists available to that practice, or other criteria may be applied in populating the drop-down menu 124 with the appropriate radiologist information.) As in FIG. 5A, a photo 126 of each radiologist is visible in the drop-down menu 124, as well as a list of the radiologist's credentials 128 (in the red box).

The example of FIG. 9 also includes a list 130 of patients. Thus, although the radiologist tracking software GUI 120 is geared towards selecting radiologists for conducting interactive sessions 200, this software may be adapted to use patient selection as the criteria for initiating the session, as in FIGS. 7A-7B. Software designers of ordinary skill in the art will recognize a number of different ways in which this initial handshaking operation between clinician 40 and radiologist 60 may be invoked.

Further, in some embodiments, the patient list 130 of the radiologist tracking software GUI 120 is updated once an interactive radiographic study session 200 of that patient has been concluded. In the example of FIG. 9, a unique icon 132 (surrounded by orange rectangle) is placed next to the patient name, thus indicating to anyone using the radiologist tracking software 76 that an interactive radiographic study session 200 has been completed for that patient. In some embodiments, by moving a mouse indicator over the icon 132, a window 134 (shown in red) emerges showing high-level characteristics of the study. For example, the study characteristics 134 might include the name of the radiologist, the name of the clinician, when the study session 200 took place, and how long the session lasted, as examples.

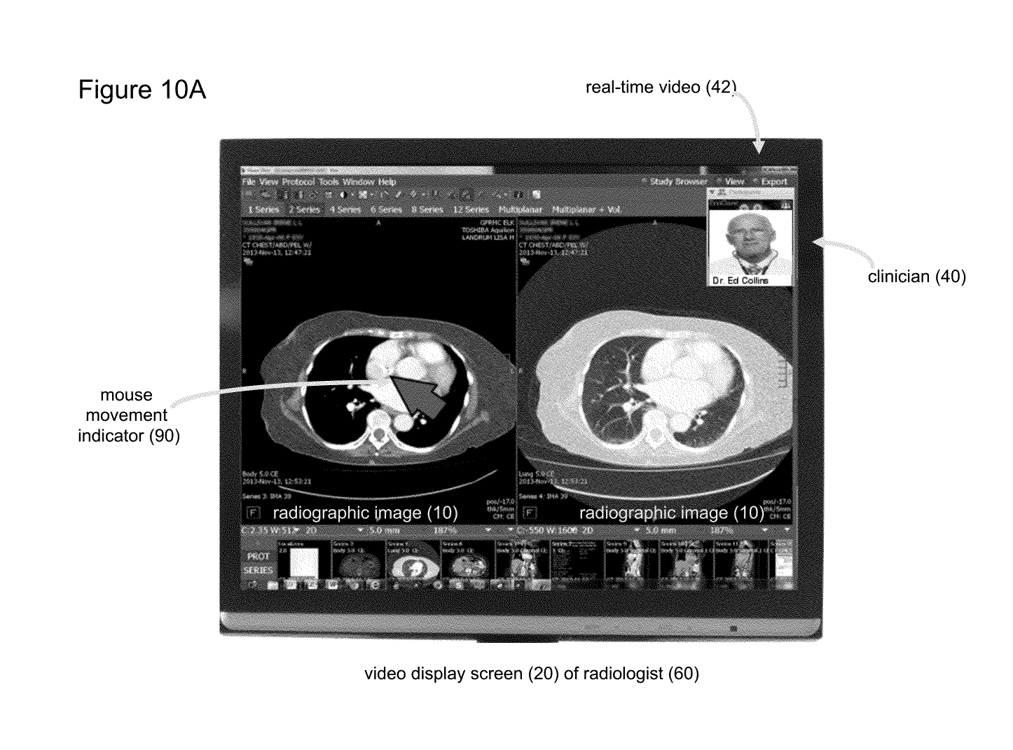

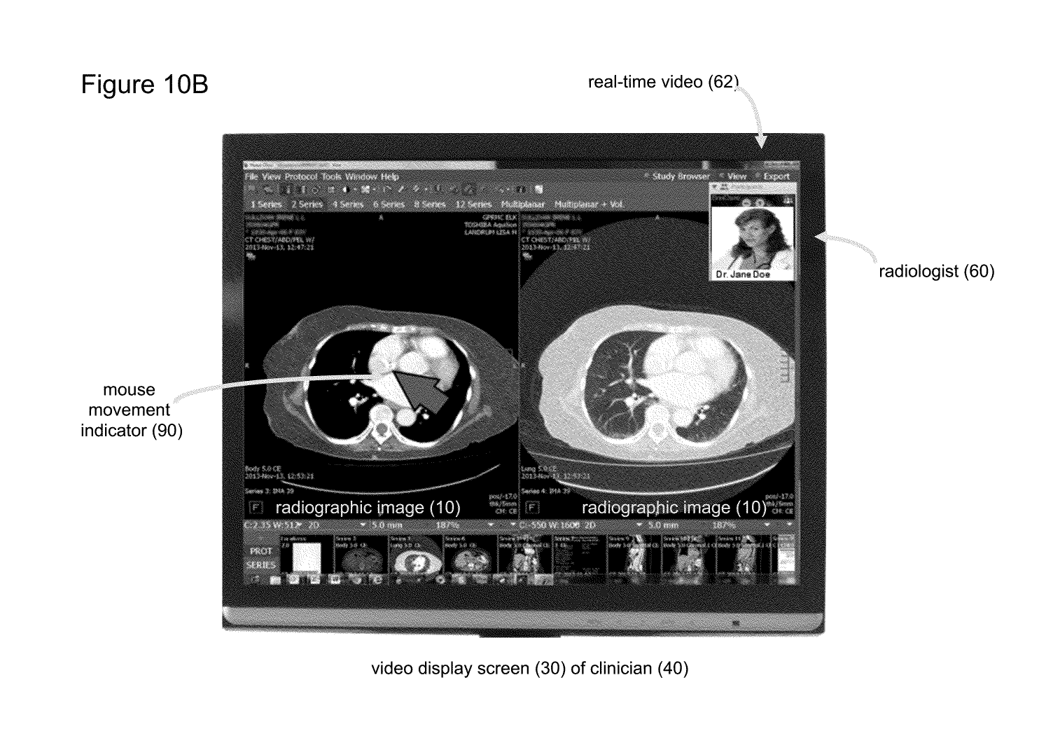

FIGS. 10A and 10B are screen shots viewed by the radiologist and clinician, respectively, once the interactive radiographic study session 200 has been invoked, according to some embodiments. FIG. 10A features the video display screen 20 of the radiologist 60 while FIG. 10B features the video display screen 30 of the clinician 40. In both FIGS. 10A an 10B, the same two radiographic images 10 are shown, with a mouse movement indicator 90 (green arrow) being moved over one of the images while the radiologist 60 and the clinician 40 discuss the images.

In FIG. 10A, the real-time video 42 of the clinician 40 is visible to the radiologist 60 while, in FIG. 10B, the real-time video 62 of the radiologist is visible to the clinician. The clinician 40 and the radiologist 60 thus communicate verbally and visually with one another through the respective real-time videos.

Once the interactive radiographic study session 200 commences, the clinician 40 and the radiologist 60 see and hear one another on their respective webcams 46/66. Additionally, the image screen of the radiologist 60 is shared with the clinician 40 so that both can see the radiographic image(s) 10 live. Both the clinician 40 and the radiologist 60 see the radiologist moving her mouse around and scrolling through the images. Further, the clinician 40 can take control of the mouse and point to parts of the radiographic image(s) 10 of interest.

Initially, the radiologist 60 is controlling a mouse at her computer 64, showing the clinician 40 that part of the radiographic image 10 about which she is speaking during the interactive radiographic study session 200. In some embodiments, the clinician 40 can request control of the mouse movement during the session 200. Once the radiologist 60 releases control of the mouse, the clinician 40 is able to move his mouse at his computer 44 over the radiographic images 10, with the mouse movement indicator 90 following the mouse movements. Control of the mouse may be toggled back and forth between the radiologist 60 and the clinician 40, as needed, until the session is completed.

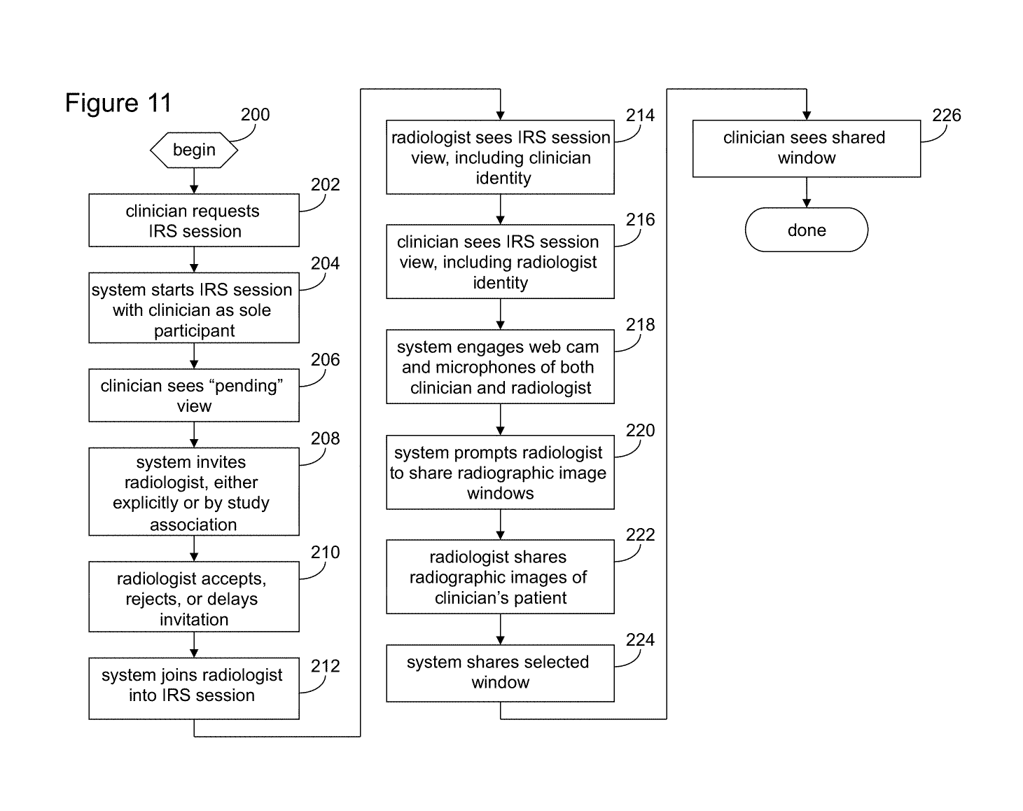

FIG. 11 is a flow diagram illustrating operations performed in establishing an interactive radiographic study session 200, according to some embodiments. The following operations are performed by the IRS software 72, in some embodiments. In the above examples, the clinician 40 invoked the interactive radiographic study (IRS) session 200 by selecting a radiologist 60 from the tracking software 76 running on his computer or by selecting a patient from the tracking software 76, with the tracking software associating the patient with a radiologist.

In this example, by contrast, the clinician 40 simply requests an interactive radiographic study session (IRS), such as by running the IRS software 72 on his computer 44 (block 202). In some embodiments, the tracking software (whether radiologist or patient) includes a dedicated icon for invoking the session 200. In other embodiments, the clinician 40 invokes the interactive radiographic study interface 100 by running the IRS software 72 (see FIG. 13). An IRS session 200 is invoked, with the clinician 40 as the sole participant (block 204). A “pending” pop-up menu is presented to the screen (block 206). Alternatively, a pop-up may appear that asks the clinician to specify a radiologist or select one from a drop-down menu.

Once the radiologist 60 is known, the IRS software 72 notifies the radiologist of the request (block 208). Or, where the session invocation is triggered by a patient selection, the radiologist is known by association to that patient. The radiologist 60 is notified such as is illustrated in FIGS. 6A-6B or FIGS. 8A-8B. The radiologist 60 accepts the invitation (block 210), and the IRS software 72 joins the radiologist into the IRS session 200 (block 212).

At this point, the radiologist 60 sees the IRS session 200 view, including the clinician identity (block 214). Likewise, the clinician 40 sees the IRS session 200 view, including the radiologist identity (block 216). The IRS software 72 engages the web cams 46 and 66 and microphones of both the clinician 40 and the radiologist 60 (block 218). Once these devices are engaged, the real-time video 42 of the clinician 40 is visible to the radiologist 60 and the real-time video 62 of the radiologist is visible to the clinician.

Next, the IRS software 72 prompts the radiologist 60 to share the radiographic images 10 of the selected patient (block 220). The radiologist 60 selects the appropriate radiographic images 10 (block 222) and the IRS software 72 shares the selected images to the session (block 224) such that the clinician 40 is able to see the images (block 226).

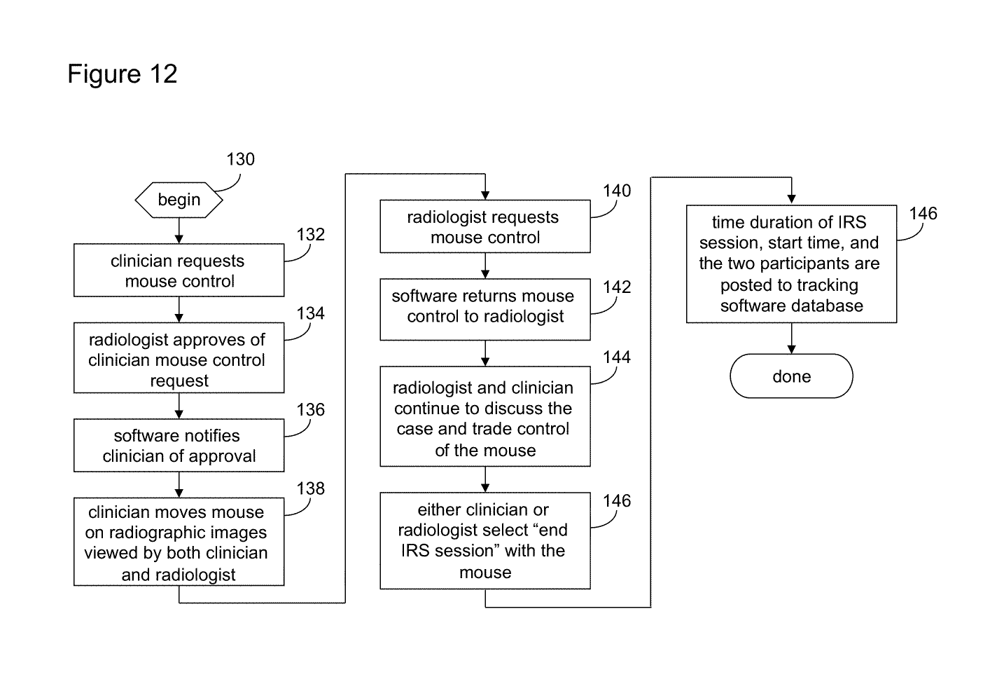

FIG. 12 is a flow diagram showing how mouse control is transferred between the radiologist 60 and the clinician 40 during the interactive radiographic session 200, according to some embodiments. The radiographic image display software 78 is running on the laptop or other workstation 64 of the radiologist 60, with the radiographic image(s) 10 being visible to the clinician 40 via the real-time screen sharing software 75 (such as WebEx). Initially, the mouse movement indicator 90 is controlled by the radiologist 60 at her workstation 64, such as in FIG. 10A. At some point during the interactive session 200, the clinician 40 may request control of the mouse (block 132). Since the clinician 40 and the radiologist 60 are observing one another via real-time video, this request may be an oral one made directly to the radiologist. Or, a dedicated keystroke sequence may invoke the request to the IRS software 72. Software designers of ordinary skill in the art will recognize a number of mechanisms by which the mouse control request may be made.

At some point, the radiologist 60 approves of the clinician mouse control request (134), which may be made by selecting an icon, by invoking a keystroke sequence, or by other means. The IRS software 72 notifies the clinician 40 that the request has been approved (block 136). In some embodiments, the request “approval” is subtle, such as changing the outline color of the mouse movement indicator 90 to indicate who has control of mouse movement over the radiographic images 10. In other embodiments, the “approval” is made explicitly, such as by a pop-up window indication. Or, the radiologist 60 may simply tell the clinician 40 that the mouse control has changed hands.

Once approval is obtained, the clinician 40 is able to move his mouse, connected to his computer or other workstation 44, such that the mouse movement indicator 90 moves over the radiographic image(s) 10 shared between the clinician and the radiologist 60 (block 138). At some point, the radiologist 60 indicates a request for control of the mouse again (block 140). Again, the radiologist 60 can simply ask the clinician 40 for a return of mouse control, since the two entities are viewing and listening to one another via the two real-time webcams 46/66. In some embodiments, the radiologist 60 maintains control over who has mouse control. The software 72 eventually returns control of the mouse movement indicator 90 to the radiologist 60 (block 142). Thereafter, the radiologist 60 and the clinician 40 are able to continue discussion about the radiographic image(s) 10, with control of the mouse traded between them as desired (block 144). Upon completion of the session 200, either the radiologist 60 or the clinician 40 select “end IRS session” (block 146).

FIG. 13 is a simplified diagram showing the interactive radiographic study session 200 invoked by the IRS software 72, according to some embodiments. The session 200 includes the view of the radiographic image(s) 10 by both the clinician 40 and the radiologist 60, and is shown on the video display screen 30 of the clinician. In this example, the screen shots that was previously shown as standalone (FIG. 10B) is now shown inside the interface 100 created by the software 72. Further, the interface 100 includes three buttons: invoke IRS session 360, mouse control request 370, and end IRS session 380. In some embodiments, these buttons may be selected by the clinician 40 to invoke the session 200, request control of the mouse from the radiologist 60, and end the session, respectively. The video display screen 20 of the radiologist 60 may be similarly presented.

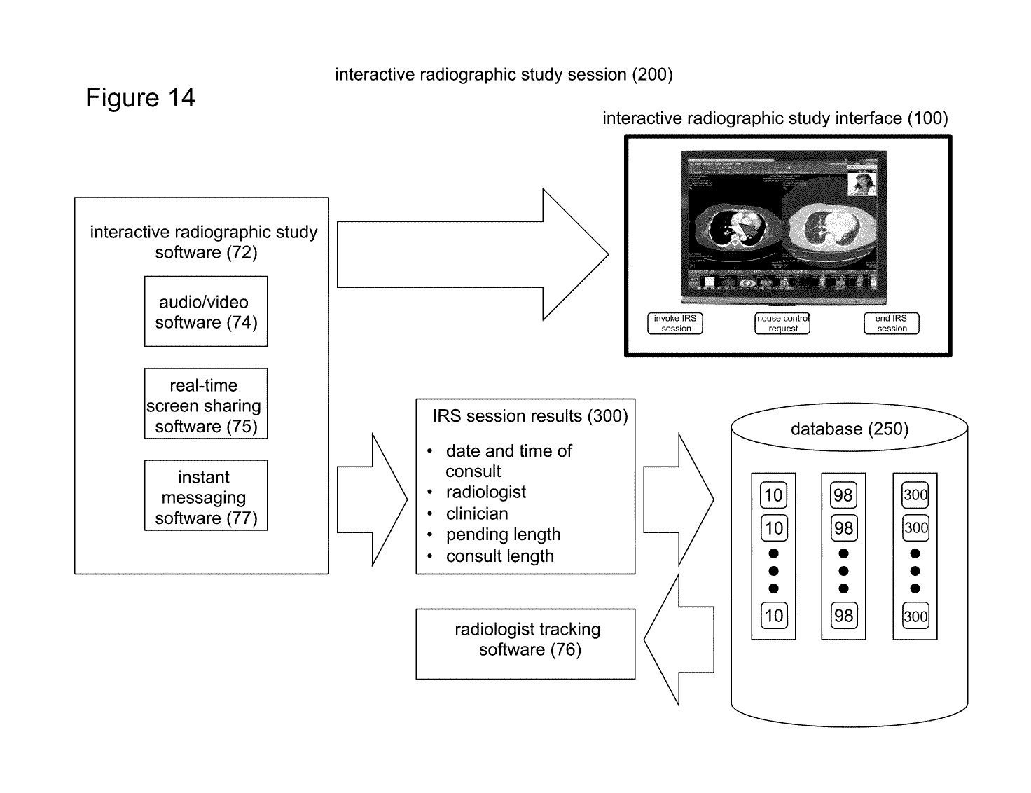

FIG. 14 is a simplified diagram showing that the IRS software 72 that invokes the interactive radiographic study session 200 does not simply result in the interactive radiographic study interface 100, but also produces IRS session results 300, such as the date and time of the consultation, the radiologist 60 involved in the consultation, the clinician 40 involved in the consultation, how long the clinician had to wait for a radiologist to engage (pending length), and how long the consultation lasted (consult length). In some embodiments, the session results are stored in a database 250, which also includes the radiographic images 120 and the patient information 98. As illustrated above, the tracking software 76 is then able to associate the session results 300 with the patient 98, the radiographic images 10, or both.

Thus, the interactive radiographic study software 72 produces an interactive radiographic study interface 100 including the commencement of an interactive radiographic study session 200 that shows a live video of the clinician 40 visible to the radiologist 60 and simultaneously shows a live video of the radiologist visible to the clinician. Further, in some embodiments, the interactive radiographic study session 200 automatically creates interactive radiographic study session results 300, which counts the time of the consult between radiologist 60 and clinician 40, records who was on the consult, and creates a report of this information that is stored in a database and accessible via icon selection to anyone who has access to the patient information.

The IRS interface 200 may be invoked from a software program that invokes the method for generating audio/video reports disclosed in U.S. Pat. No. 8,434,005, entitled, AUDIO/VIDEO REPORT FOR RADIOLOGY, issued on Apr. 30, 2013. The patent discloses a method for generating audio/video reports of a radiologist's interpretation of one or more radiographic images, and includes text, audio, and video that become part of the patient's file which is thereafter stored in a database and accessible for subsequent viewing.

While the application has been described with respect to a limited number of embodiments, those skilled in the art will appreciate numerous modifications and variations therefrom. It is intended that the appended claims cover all such modifications and variations as fall within the true spirit and scope of the invention.

We claim:

1. A method to interactively review a radiographic study comprising one or more radiographic images of a patient, the method comprising:
requesting, by a clinician, a session, wherein the request is executed by a software program;
viewing, by the clinician, a real-time video of a radiologist associated with the requested session on a video monitor coupled to a processor-based system, wherein a microphone and digital camera, when activated, enable two-way communication with the radiologist; and
viewing, by the clinician, the radiographic study on the video monitor, wherein the radiographic study is shared with the clinician by the radiologist;
wherein the radiographic study is viewable using a second software program remote to the processor-based system.

2. The method of claim 1, further comprising:
observing, by the clinician, a pointer moving over the radiographic study on the video monitor, the pointer to indicate movement of a mouse, wherein the processor-based system of the clinician includes a second mouse that does not control the pointer;
requesting, by the clinician, control of the pointer by the second mouse; and
moving, by the clinician, the second mouse over the radiographic study, wherein the pointer is controlled by the second mouse.

3. The method of claim 2, further comprising:
acknowledging, by the clinician, a request to return control of the pointer to the mouse;
wherein the pointer is thereafter controlled by the mouse in the possession of the radiologist.

4. The method of claim 1, further comprising:
speaking, by the clinician, to the radiologist by looking at the real-time video of the radiologist on the video monitor;
wherein the radiologist sees a second real-time video of the clinician once the digital camera and microphone of the processor-based system are turned on.

5. The method of claim 1, wherein the session request is made by accessing a web page generated by the software program and viewable on the video monitor of the processor-based system.

6. The method of claim 1, wherein the session request is made by accessing a graphical user interface generated by the software program and viewable on the video monitor of the processor-based system.

7. The method of claim 1, further comprising:
requesting, by the clinician, a cessation of the session, wherein the software program generates a session results file and stores the session results file in a database.

8. The method of claim 7, wherein the session results file comprises:
a date and time of the session;
a name of the radiologist involved in the session;
a second name of the clinician involved in the session;
a first length of time comprising how long the clinician waited for the radiologist to enter the session; and
a second length of time comprising how long the session lasted.

9. The method of claim 8, further comprising:
associating the session results file with the patient.

10. A method to interactively review a radiographic study comprising one or more radiographic images of a patient viewable on an interface of a video display of a processor-based system, the method comprising:
requesting, by a clinician, a radiologist with whom to conduct an interactive session, wherein the request is selected from a menu of available radiologists in a software program accessible to the processor-based system; and
viewing, by the clinician, the radiographic study on the video monitor, the radiographic study to be shared with the clinician by the radiologist;
wherein a pointer moving over the radiographic study is not controlled by the clinician.

11. The method of claim 10, further comprising:
viewing, by the clinician, a real-time video of the radiologist associated with the requested session on a video monitor coupled to the processor-based system, wherein a microphone and digital camera on the processor-based system, when activated, enable the radiologist to view a second real-time video of the clinician.

12. The method of claim 8, further comprising:
observing, by the clinician, a pointer moving over the radiographic study on the video monitor, the pointer to indicate movement of a mouse, wherein the processor-based system of the clinician includes a second mouse that is not being moved;
requesting, by the clinician, control of the pointer; and
moving, by the clinician, the second mouse over the radiographic study, wherein the pointer is controlled by the second mouse.

13. The method of claim 12, further comprising:
receiving a request, by the clinician, to give up control of the pointer by the second mouse; and
giving up control of the pointer by the clinician;
wherein the pointer is thereafter controlled by the mouse.

14. The method of claim 12, requesting, by the clinician, control of the pointer further comprising:
speaking to the radiologist via the real-time video to make the request.

15. The method of claim 12, requesting, by the clinician, control of the pointer further comprising:
moving the second mouse over a mouse request icon; and
clicking the second mouse;
wherein the radiologist is notified of the request by an instant message.

16. The method of claim 10, further comprising:
requesting, by the clinician, that the interactive session be ended;
wherein a session results report is generated and thereafter associated with the patient.

17. The method of claim 16, wherein the request to end the interactive session is made orally by the clinician to the radiologist.

18. The method of claim 16, wherein the request to end the interactive session is made by selecting a button on the interface.

19. An interactive radiographic study session, comprising a software program executable on a processor-based system, the software program to invoke a graphical user interface (GUI) viewable on a video display screen coupled to the processor-based system executing the software program, the GUI further comprising:
means to invoke the session;
one or more radiographic images viewable by a second software program, wherein the second software program is executed on a second processor-based system remote to the processor-based system;
a real-time streaming video of a radiologist controlling the one or more radiographic images on the second processor-based system using a mouse coupled to the second processor-based system, with a mouse movement indicator being visible on the GUI; and
means to end the session;
wherein the software program further generates session results and stores the session results in a database.

20. The interactive radiographic study session of claim 19, further comprising:
means to change control of the mouse movement indicator;
wherein the mouse movement indicator is controlled by a second mouse coupled to the processor-based system.
